(19) United States
(12) Patent Application Publication
(10) Pub. No.: US 2024/0000275 A1
(43) Pub. Date: Jan. 4, 2024

(54) HANDHELD VACUUM CLEANER WITH IMPROVED FILTRATION EFFICIENCY

(71) Applicant: Dreame Innovation Technology (Suzhou) Co., LTD., Suzhou City, Jiangsu Province (CN)

(72) Inventors: RU ZHANG, Suzhou City, Jiangsu Province (CN); SUXIANG FAN, Suzhou City, Jiangsu Province (CN)

(21) Appl. No.: 18/039,489

(22) PCT Filed: Sep. 22, 2021
(86) PCT No.: PCT/CN2021/119607

§ 371 Date: May 30, 2023

(30) Foreign Application Priority Data
Feb. 22, 2021 (CN) 202110199115.8
Feb. 22, 2021 (CN) 202120390908.3

(51) Int. Cl. A47L 9/16; A47L 5/24; A47L 9/14; A47L 9/22; A47L 9/12; A47L 9/32; B04C 3/04; B04C 3/06; B04C 9/00

(52) U.S. Cl. CPC A47L 9/1641; A47L 5/24; A47L 9/1409; A47L 9/22; A47L 9/127; A47L 9/1683; A47L 9/165; A47L 9/1658; A47L 9/1608; A47L 9/322; B04C 3/04; B04C 3/06; B04C 9/00; B04C 2009/002; B04C 2009/005

(57) ABSTRACT

A handheld vacuum cleaner includes a dust cup assembly, a multi-cone separator and a motor assembly. The dust cup assembly includes a dust cup and a first filter structure. The multi-cone separator includes a number of conical cylinders arranged outside the first filter structure. Air inlet ends of the number of conical cylinders are in fluid communication with an air outlet end of the first filter structure. The motor assembly includes a motor arranged outside the first filter structure. The motor and the number of conical cylinders are located at a same end of the first filter structure. An air inlet end of the motor is in fluid communication with an air outlet end of the multi-cone separator. The number of the conical cylinders at least partially surround a peripheral side of the motor.

### TECHNICAL FIELD

The present invention relates to the technical field of cleaning devices, in particular to a handheld vacuum cleaner.

### BACKGROUND

Handheld vacuum cleaners vacuum up garbage or dust in the environment, and are popular among users because of their ease of use and light weight. However, in traditional handheld vacuum cleaners, the multi-cone separator is generally located inside a filter, which makes the filter in the handheld vacuum cleaner relatively large in size and low in filtration efficiency.

### SUMMARY

In order to solve the above technical problems, a main object of the present invention is to provide a handheld vacuum cleaner, aiming to solve the problems of large volume and low filtration efficiency of traditional handheld vacuum cleaners.

In order to achieve the above object, a handheld vacuum cleaner proposed by the present invention includes:
a dust cup assembly, including a dust cup and a first filter structure arranged in the dust cup, the first filter structure being arranged in a ring shape;
a multi-cone separator, including a plurality of conical cylinders arranged outside the first filter structure and located at one end of the first filter structure along an axial direction; air inlet ends of the plurality of conical cylinders being in fluid communication with an air outlet end of the first filter structure; and
a motor assembly, including a motor arranged outside the first filter structure, the motor and the plurality of conical cylinders being located at a same end of the first filter structure; an air inlet end of the motor being in fluid communication with an air outlet end of the multi-cone separator; the plurality of the conical cylinders at least partially surrounding a peripheral side of the motor.

In one embodiment, the motor assembly further includes a printed circuit board electrically connected to the motor, and the printed circuit board is located at an end of the motor adjacent to the first filter structure.

In one embodiment, the plurality of conical cylinders are all arranged along an axial direction of the motor; a dust falling port is formed at a constricted end of each of the conical cylinders; an air outlet is formed at an open end of each of the conical cylinders; an air inlet of each of the conical cylinders is formed on a side wall of the conical cylinder and arranged adjacent to the open end; and the air inlet of each of the conical cylinders is located on a side of the printed circuit board facing away from a filter screen.

In one embodiment, the air inlets of the conical cylinders are arranged between the air outlet end of the first filter structure and the air inlet end of the motor.

In one embodiment, the motor and the first filter structure are arranged coaxially; or,
a central axis of the motor and a central axis of the first filter structure are arranged in a misaligned manner.

In one embodiment, the plurality of the conical cylinders are arranged outside the motor along a circumferential direction of the motor, and the plurality of conical cylinders are arranged in an arc shape.

In one embodiment, the dust cup assembly further includes a dust guide cylinder arranged inside the first filter structure; the dust guide cylinder is arranged along the axial direction of the first filter structure; one end of the dust guide cylinder is arranged facing the motor and in communication with the dust falling ports of the plurality of conical cylinders; and another end of the dust guide cylinder is configured to discharge dust;
the dust guide cylinder and the first filter structure are arranged at intervals to form an air passing channel; the air passing channel is in fluid communication with the plurality of air inlets of the conical cylinders; the air passing channel is configured to deliver an airflow filtered by the first filter structure to the plurality of air inlets of the conical cylinders.

In one embodiment, the motor assembly further includes a motor mounting plate, the motor mounting plate closing an end of the dust guide cylinder facing the motor, the motor is installed on the motor mounting plate, a plurality of first through holes are opened on the motor mounting plate, and the plurality of first through holes are arranged in one-to-one correspondence with the plurality of dust falling ports of the conical cylinders.

In one embodiment, the handheld vacuum cleaner further includes a housing mating with the dust cup; wherein an accommodating cavity is formed in the housing; both the motor assembly and the multi-cone separator are arranged in the accommodating cavity;
the multi-cone separator further includes a separation cover plate arranged at the air outlets of the plurality of conical cylinders; the separation cover plate is configured to divide the accommodating cavity into a first cavity and a second cavity which are arranged along the axial direction of the motor; the separation cover plate defines a plurality of second through holes arranged in one-to-one correspondence with the plurality of air outlets of the conical cylinders; the air inlets of the conical cylinders are located in the second cavity; and the air inlet end of the motor is located in the first cavity.

In one embodiment, the air inlet end of the motor defines a plurality of air inlet holes which are arranged annularly along a circumferential direction of the motor;
the handheld vacuum cleaner further includes a second filter structure arranged in the first cavity; the second filter structure is arranged surrounding an outside of the plurality of air inlet holes; the plurality of second through holes are arranged on an outside of the second filter structure; and/or,
the air outlet end of the motor is located in the second cavity; the handheld vacuum cleaner further includes a handheld structure arranged on one side of the housing; an air outlet hole is opened on the handheld structure; the handheld structure defines an air outlet channel in communication with the air outlet hole and the air outlet end of the motor; and the air outlet channel and the air passing channel are arranged separately.

The handheld vacuum cleaner provided by the present invention includes the dust cup assembly, the multi-cone separator and the motor assembly. By arranging the multi-cone separator and the motor on the outside of the first filter structure, a diameter of the first filter structure can be reduced and the filtration efficiency of the first filter structure can be improved, thereby the dust suction effect of the handheld vacuum cleaner is improved, while an overall size of the handheld vacuum cleaner remains unchanged. Moreover, the plurality of conical cylinders of the multi-cone separator are arranged around the motor, so that the structure of the handheld vacuum cleaner is more compact and the volume is smaller. As a result, compared with traditional handheld vacuum cleaners, the handheld vacuum cleaner provided by the present invention can not only effectively improve the dust suction effect of the vacuum cleaner, but also have a smaller volume and better user experience.

### BRIEF DESCRIPTION OF DRAWINGS

In order to more clearly illustrate the embodiments of the present invention or the technical solutions in the prior art, the following briefly introduces the drawings required for the description of the embodiments or the prior art. Obviously, the drawings in the following description are only some embodiments of the present invention. For those skilled in the art, other drawings can also be obtained according to the structures shown in these drawings without creative effort.

FIG. 1 is a schematic structural view of a handheld vacuum cleaner provided by an embodiment of the present invention;

FIG. 2 is a structural schematic view of the handheld vacuum cleaner (excluding a housing and a second filter structure) shown in FIG. 1;

FIG. 3 is a schematic cross-sectional structure view of the handheld vacuum cleaner shown in FIG. 1;

FIG. 4 is a schematic cross-sectional structure view of the handheld vacuum cleaner in FIG. 1 from another viewing angle;

FIG. 5 is a schematic view of an enlarged structure of detail A in FIG. 4;

FIG. 6 is a schematic cross-sectional structure view of the handheld vacuum cleaner in FIG. 1 from another viewing angle;

FIG. 7 is a schematic structural view of a separator shown in FIG. 1;

FIG. 8 is a schematic structural view of conical cylinders shown in FIG. 1;

FIG. 9 is a structural schematic view of a dust cup shown in FIG. 1; and

FIG. 10 is a structural schematic view of a handheld structure in FIG. 1.

### EXPLANATION OF REFERENCE NUMBERS

| reference number | name | reference number | name |
|---|---|---|---|
| 100 | handheld vacuum cleaner | 4 | dust cup assembly |
| 1 | vacuum main body | 41 | dust cup |
| 11 | housing | 42 | first mounting portion |
| 12 | first cavity | 421 | slider |
| 13 | second cavity | 43 | second mounting portion |
| 14 | second mating portion | 431 | buckle portion |
| 141 | hook | 44 | first filter structure |
| 15 | opening | 441 | filter screen mounting |
| | | | bracket |
| 2 | multi-cone separator | 442 | filter screen |
| 21 | conical cylinder | 45 | dust guide cylinder |
| 211 | air inlet | 5 | second filter structure |
| 212 | air outlet | 6 | handheld structure |
| 213 | dust falling port | 61 | first mating portion |
| 22 | separation cover plate | 611 | sliding slot |
| 23 | second through hole | 7 | dust-scraping assembly |
| 3 | motor assembly | 71 | dust-scraping member |
| 31 | motor | 72 | dust-scraping drive |
| | | | structure |
| 32 | air inlet hole | 721 | guide rod |
| 33 | printed circuit board | 722 | connecting rod |
| 34 | motor mounting plate | 723 | driving handle |
| 35 | first through hole | 724 | elastic reset member |

The realization of the object of the present invention, functional characteristics and excellent effects will be further described below in conjunction with specific embodiments and accompanying drawings.

### DETAILED DESCRIPTION

The technical solutions of the present invention will be clearly and completely described below with reference to the accompanying drawings of the present invention. Obviously, the described embodiments are some, but not all, embodiments of the present invention. Based on the embodiments in the present invention, all other embodiments obtained by those of ordinary skill in the art without creative efforts shall fall within the protection scope of the present invention.

It should be noted that if there is a directional indication in the embodiment of the present invention, the directional indication is only used to explain the relative positional relationship and movement conditions among the components in a certain posture. If the specific posture changes, the directional indication also changes accordingly.

In addition, if there are descriptions involving “first”, “second” and so on in the embodiments of the present invention, the descriptions of “first”, “second” and so on are only for descriptive purposes, and should not be interpreted as indicating or implying their relative importance or implicitly indicating the number of indicated technical features. Thus, the features defined as “first” and “second” may explicitly or implicitly include at least one of these features. In addition, the meaning of “and/or” appearing in the whole text includes three parallel schemes. Taking “A and/or B” as an example, it includes a solution A, a solution B, or a solution that satisfies both the solution A and the solution B. In addition, the technical solutions of the various embodiments can be combined with each other, but it must be based on the realization of those skilled in the art. When the combination of technical solutions contradicts each other or cannot be realized, it should be considered that the combination of technical solutions does not exist, and is not within the protection scope of the present invention.

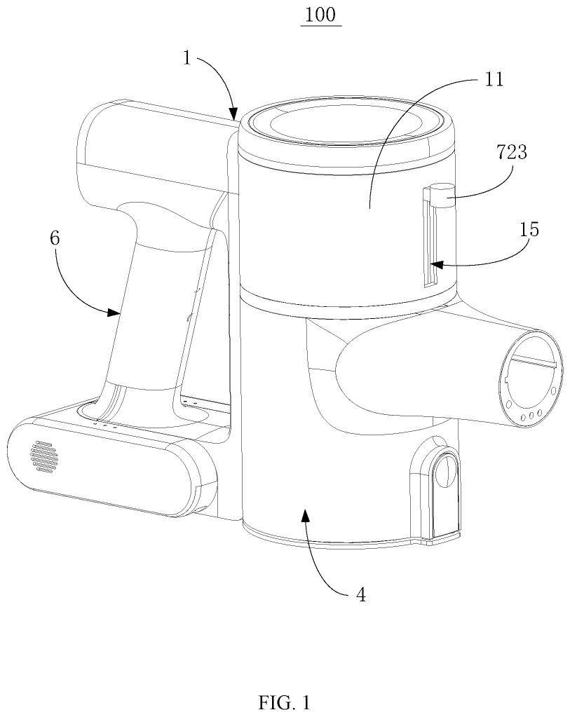

The present invention provides a handheld vacuum cleaner. FIG. 1 to FIG. 10 shows an embodiment of the handheld vacuum cleaner provided by the present invention.

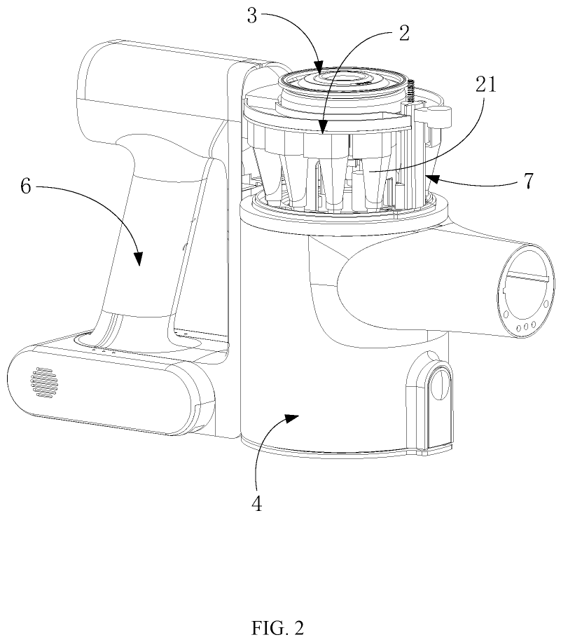

Referring to FIG. 1 to FIG. 2, in the present embodiment, the handheld vacuum cleaner 100 includes a vacuum main body 1, a dust cup assembly 4, a multi-cone separator 2 and a motor assembly 3.

Wherein, the vacuum main body 1 may include a housing 11 and electrical components disposed in the housing 11 to control the operation of the handheld vacuum cleaner 100. The layout of the circuit structure in the vacuum main body 1 can adopt traditional technology, which will not be explained here.

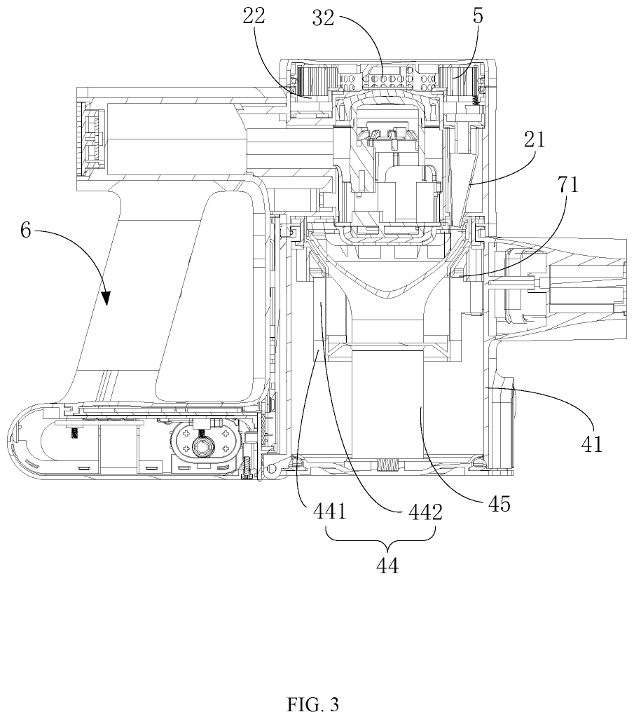

Referring to FIG. 3, the dust cup assembly 4 includes a dust cup 41 and a first filter structure 44. The dust cup 41 defines a storage cavity that can store garbage. The first filter structure 44 is arranged in the dust cup 41, and is used to filter an airflow entering the dust cup 41 from a dust suction port of the dust cup 41, thereby outputting clean air to the handheld vacuum cleaner 100, and keeping the filtered garbage in the storage cavity of the dust cup 41. Since the dust cup 41 is generally arranged in a cylindrical shape, the first filter structure 44 is also arranged in a ring shape in order to improve the filtering effect. The first filter structure 44 is a primary filter structure in the handheld vacuum cleaner 100. Preferably, a shape of the first filter structure 44 is adapted to a shape of the dust cup 41, and the filtration efficiency is higher.

Referring to FIG. 2 and FIG. 3, the multi-cone separator 2 is a secondary filter structure in the handheld vacuum cleaner 100. The multi-cone separator 2 includes a plurality of conical cylinders 21 arranged outside the first filter structure 44. The plurality of conical cylinders 21 are located at one end of the first filter structure 44 along an axial direction, so that the size of the first filter structure 44 can be set smaller, the size of the whole handheld vacuum cleaner 100 can be reduced, and the filtration efficiency of the first filter structure 44 can also be improved. The air inlet ends of the plurality of conical cylinders 21 are in fluid communication with the air outlet ends of the first filter structure 44, so as to perform secondary filtration on the airflow entering the handheld vacuum cleaner 100. As a result, the airflow output to the user's room is cleaner.

The motor assembly 3 is used to form a vacuum. The dust and other garbage in the user's room can be sucked through the dust suction port on the dust cup. The motor assembly 3 includes a motor 31 disposed outside the first filter structure 44. The motor 31 and the plurality of conical cylinders 21 are located at a same end of the first filter structure 44, and the air inlet end of the motor 31 is in fluid communication with the air outlet end of the multi-cone separator 2. The plurality of conical cylinders 21 at least partially surround the motor 31. Both the multi-cone separator 2 and the motor 31 are arranged outside the first filter structure 44, so that the size of the first filter structure 44 can be flexibly adjusted. Compared with the traditional handheld vacuum cleaner 100, the volume of the first filter structure 44 can be smaller to improve the filtration efficiency. Moreover, the plurality of conical cylinders 21 are arranged around the motor 31 to make the structure more compact, so that the volume of the handheld vacuum cleaner 100 can be smaller.

In the present invention, both the multi-cone separator 2 and the motor 31 are arranged outside the first filter structure 44. When the overall size of the handheld vacuum cleaner 100 remains unchanged, the diameter of the first filter structure 44 can be reduced to improve the filtration efficiency of the first filter structure 44, thereby improving the dust suction effect of the handheld vacuum cleaner 100. Moreover, the plurality of conical cylinders 21 of the multi-cone separator 2 are arranged around the motor 31, so that the structure of the handheld vacuum cleaner 100 is more compact and the volume is smaller. Therefore, compared with the traditional handheld vacuum cleaner 100, the handheld vacuum cleaner 100 provided by the present invention can not only effectively improve the dust suction effect of the vacuum cleaner, but also can be set to be smaller in size and provide better user experience.

In the present embodiment, the motor 31 can be turned on and off by a controller in the handheld vacuum cleaner 100. Specifically, the motor assembly 3 further includes a printed circuit board 33 electrically connected to the motor 31. The printed circuit board 33 is located at one end of the motor 31 adjacent to the first filter structure 44, so that the air outlet end of the motor 31 is located at an end far away from the first filter structure 44. The operation of the motor 31 is controlled by the controller disposed on the printed circuit board 33. Of course, an operation button may be provided on the housing of the handheld vacuum cleaner 100, and the operation of the motor 31 is controlled by pressing the operation button, which may be more convenient to operate.

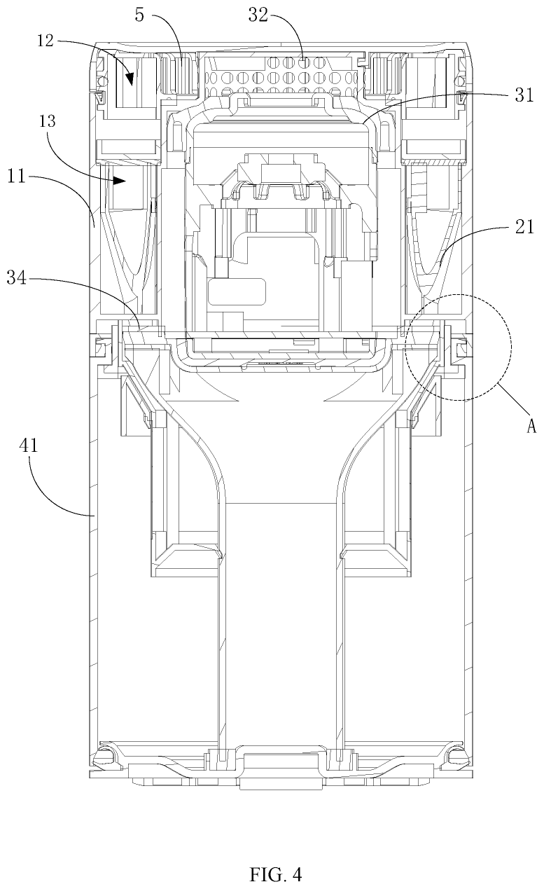

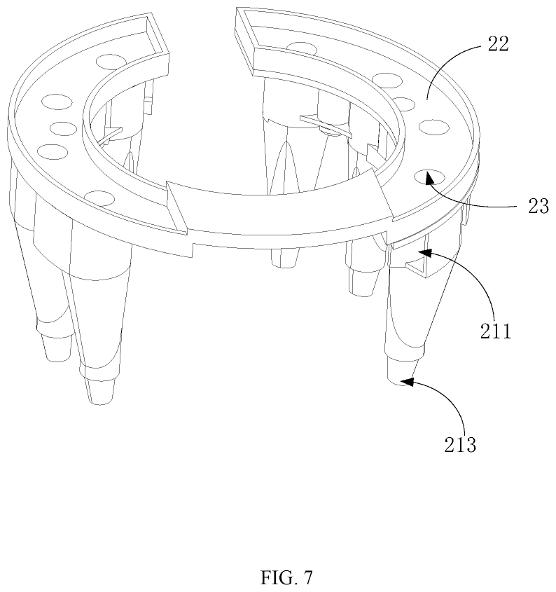

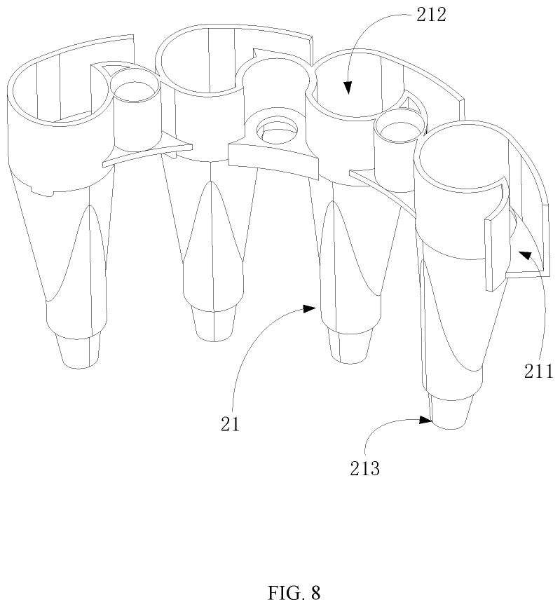

Further, in conjunction with FIG. 4, FIG. 7 and FIG. 8, since the plurality of conical cylinders 21 are surrounded on the outside of the motor 31, in order to make the structure more compact, the plurality of the conical cylinders 21 are all disposed along the axial direction of the motor 31, so as to be arranged in parallel with the motor 31. As a result, the conical cylinders 21 can fit the motor 31 more closely. The working principle of the conical cylinders 21 is a traditional technology. Generally, the conical cylinder 21 has three openings, namely an air inlet 211, an air outlet 212 and a dust falling port 213, to further separate dust from the airflow filtered out by the first filter structure 44. The air inlet 211 is used to introduce the airflow exported by the first filter structure 44 into the conical cylinder 21. Because the dust is heavier than the air, after passing through the conical cylinder 21, the heavier dust falls out from the dust falling port 213, and the clean airflow is introduced into the motor 31 through the air outlet 212. Specifically, the dust falling port 213 is formed at a constricted end of each of the conical cylinders 21. The air outlet 212 is formed at an open end of each of the conical cylinders 21. The air inlet 211 of each of the conical cylinders 21 is formed on a side wall of the conical cylinder 21, and an air deflector is provided at an edge of the air inlets 211 to form a spiral airflow into the conical cylinders 21. The air inlets 211 are arranged adjacent to the open end, so that dust has enough space to fall. The air inlets 211 of each of the conical cylinders 21 are located on a side of the printed circuit board 33 facing away from a filter screen 442, so as to prevent the printed circuit board 33 from being contaminated with dust.

Moreover, the air inlets 211 of the conical cylinders 21 are disposed between the air outlet end of the first filter structure 44 and the air inlet end of the motor 31 to filter the airflow sucked into the handheld vacuum cleaner 100 for the second time. The airflow is exported from the motor 31 again, and the filtering effect is better.

The plurality of the conical cylinders 21 are arranged outside the motor 31 along a circumferential direction of the motor 31. In one embodiment, the plurality of conical cylinders 21 can be arranged on the outer side of the motor 31 in a complete circle.

In another embodiment, the plurality of the conical cylinders 21 may also be arranged in an arc shape, and as few conical cylinders 21 as possible are provided to meet the filtration efficiency, which can save costs.

In one embodiment, in order to make the volume of the handheld vacuum cleaner 100 smaller, the motor 31 and the first filter structure 44 can be arranged coaxially.

Of course, in another embodiment, when the shape of the handheld vacuum cleaner 100 is configured in a special shape, a central axis of the motor 31 and a central axis of the first filter structure 44 can also be set in a misalignment so as to match the shape of the handheld vacuum cleaner 100 for reasonable arrangement.

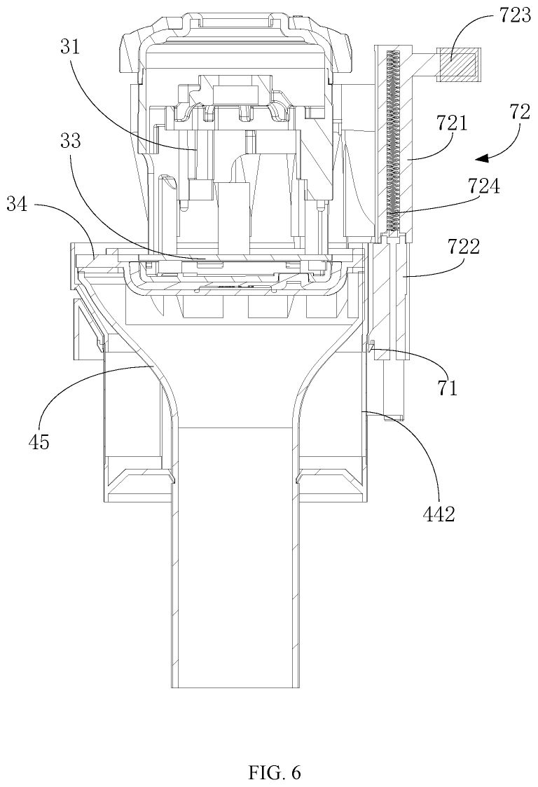

Referring to FIG. 4, FIG. 6 and FIG. 7, in order to ensure that the airflow filtered by the first filter structure 44 can enter the conical cylinders 21, and the dust filtered by the conical cylinders 21 can fall into the storage cavity in the dust cup 41, the dust cup assembly 4 further includes a dust guide cylinder 45 disposed inside the first filter structure 44. The dust guide cylinder 45 is arranged along the axial direction of the first filter structure 44. The dust guide cylinder 45 is arranged in a cylindrical shape with both ends open. One end of the dust guide cylinder 45 is disposed toward the motor 31 for communicating with the dust falling ports 213 of the plurality of conical cylinders 21. The other end of the dust guide cylinder 45 is used to discharge dust into the storage cavity. In addition, the dust guide cylinder 45 and the first filter structure 44 are arranged at intervals to form an air passing channel. The air passing channel is in fluid communication with the plurality of air inlets 211 of the conical cylinders 21. The air passing channel is used to deliver the airflow filtered by the first filter structure 44 to the air inlets 211 of the plurality of conical cylinders 21, and the inside of the dust cup 41 is partitioned by the dust guide cylinder 45, thereby realizing the secondary filtration of the air.

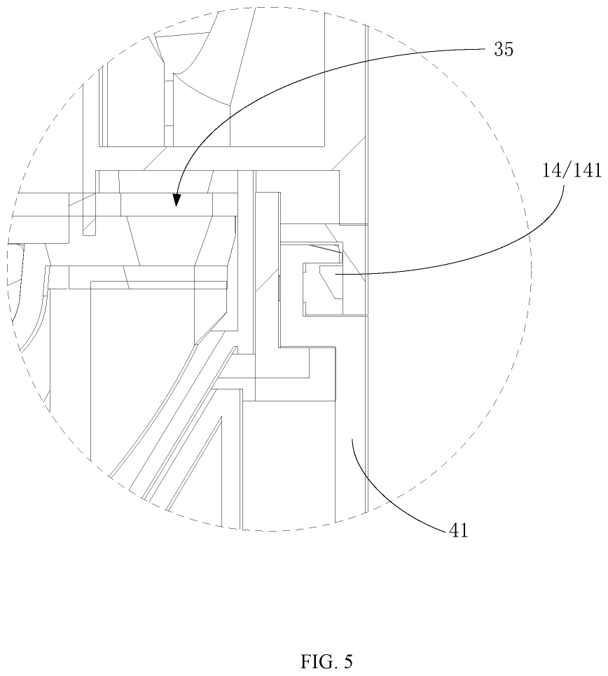

Further, in order to prevent dust from entering the motor 31 and damaging the motor 31, referring to FIG. 5 and FIG. 6, the motor assembly 3 further includes a motor mounting plate 34. The motor mounting plate 34 closes the end of the dust guide cylinder 45 facing the motor 31 to prevent the dust in the dust guide cylinder 45 from entering the motor 31. The motor 31 is mounted on the motor mounting plate 34. A plurality of first through holes 35 are opened on the motor mounting plate 34. The plurality of first through holes 35 are arranged in one-to-one correspondence with the plurality of dust falling ports 213 of the conical cylinders 21. The dust filtered by the conical cylinders 21 enters the dust guide cylinder 45 from the first through holes through the dust falling ports 213.

It is understandable that, in order to make the appearance of the handheld vacuum cleaner 100 more beautiful, referring to FIG. 1, FIG. 7 and FIG. 8, the motor assembly 3 and the multi-cone separator 2 is wrapped with a housing 11. The housing 11 is in contact with the dust cup 41, so that the housing 11 is connected with the dust cup 41. An accommodating cavity is formed in the housing 11. Both the motor assembly 3 and the multi-cone separator 2 are located in the accommodating cavity. The multi-cone separator 2 further includes a separation cover plate 22 arranged at the air outlets 212 of the plurality of conical cylinders 21. The separation cover plate 22 is used to divide the accommodating cavity into a first cavity 12 and a second cavity 13 arranged along the axial direction of the motor 31. The separation cover plate 22 is used to separate the air inlet end and the air outlet end of the motor 31. A plurality of second through holes 23 corresponding to the plurality of air outlets 212 of the conical cylinders 21 are opened on the separation cover plate 22. The air inlet 211 of each of the conical cylinders 21 is located in the second cavity 13. The air outlet 212 of each conical cylinder 21 is also located in the second cavity 13. The air inlet end of the motor 31 is located in the first cavity 12. The second cavity 13 communicates with the air outlet end of the first filter structure 44. The airflow filtered by the first filter structure 44 enters the second cavity 13, and then enters the air inlets 211 of the conical cylinders 21. The airflow is led out into the first cavity 12 through the air outlets 212 of the conical cylinders 21, and then enters the motor 31 through the air inlet end of the motor 31. Finally, the airflow is exported from the air outlet end of the motor 31 to the user's room. Of course, an air outlet hole may be provided on the housing 11 of the handheld vacuum cleaner 100 or on other housings, so as to guide the clean airflow from the air outlet end of the motor 31.

A plurality of air inlet holes 32 are opened at the air inlet end of the motor 31. The plurality of air inlet holes 32 are arranged in a ring shape along the circumference of the motor 31, corresponding to the plurality of conical cylinders 21 surrounding the motor 31, so that the air inlet of the motor 31 is smoother. Moreover, in order to ensure the purity of the airflow entering the motor 31 and avoid affecting the operation of the motor 31, the handheld vacuum cleaner 100 further includes a second filter structure 5 disposed in the first cavity 12. The second filter structure 5 is disposed outside the plurality of air inlet holes 32, and the plurality of second through holes 23 are disposed outside the second filter structure 5. The second filter structure 5 is used to further filter the airflow entering the motor 31. The second filter structure 5 can be set as an air-inlet HEPA, which is low in cost and easy to replace.

When the air outlet end of the motor 31 is located in the second cavity 13, referring to FIG. 1 to FIG. 3, the handheld vacuum cleaner 100 further includes a handheld structure 6 arranged on one side of the housing 11. The handheld structure 6 can be used to be held by the user, which is more convenient to operate during use. At this time, the air outlet can be arranged on the handheld structure 6. An air outlet channel in communication with the air outlet hole and the air outlet end of the motor 31 is formed in the handheld structure 6. In addition, the air outlet channel is separated from the air passing channel. Specifically, the air outlet channel and the air passing channel can be isolated by the separation cover plate, so that each air channel does not affect each other, and the motor 31 can be effectively protected.

The above content is mainly to improve the arrangement of the multi-cone separator 2 in the handheld vacuum cleaner 100, so that the handheld vacuum cleaner 100 has a better filtering effect and a smaller volume. Another embodiment of the present invention is proposed below, which can make cleaning the dust cup 41 of the handheld vacuum cleaner 100 more convenient.

In the present embodiment, referring to FIG. 1 to FIG. 3, the handheld vacuum cleaner 100 may further include a dust-scraping assembly 7. The dust-scraping assembly 7 is used to scrape off the dust on the outside of the first filter structure 44, so as to facilitate the treatment of the dust on the first filter structure 44 and prevent the first filter structure 44 from being blocked.

The above dust-scraping assembly 7 can be set as a separate component in the handheld vacuum cleaner 100. Of course, the layout may also be performed on the basis of the above-mentioned embodiments.

Specifically, referring to FIG. 3 and FIG. 6, the dust-scraping assembly 7 includes a dust-scraping member 71 and a dust-scraping driving structure 72. The dust-scraping member 71 is movably arranged on the outside of the first filter structure 44. The dust-scraping driving structure 72 is connected with the dust-scraping member 71. The dust-scraping driving structure 72 is installed on the housing 11 to drive the dust-scraping member 71 to reciprocate along the axial direction of the first filter structure 44 to scrape off the dust on the outside of the first filter structure 44.

There are various arrangements of the dust-scraping driving structure 72. In one embodiment, the dust-scraping driving structure 72 can be configured to drive a cylinder or a motor to drive the dust-scraping member 71 to reciprocate.

In another embodiment, referring to FIG. 6, the dust-scraping driving structure 72 includes a guide rod 721, a connecting rod 722 and a connecting rod driving member. The guide rod 721 is disposed in the housing 11. The guide rod 721 is hollow and extends along the axial direction of the first filter structure 44, so as to guide the connecting rod 722 to make the dust-scraping member 71 reciprocate along the outer side of the first filter structure 44. The connecting rod 722 is movably passed through the guide rod 721 and connected with the dust-scraping member 71. The connecting rod driving member is connected with the connecting rod 722 for driving the connecting rod 722 to move along a length direction of the guide rod 721. The connecting rod 722 is driven to reciprocate along the guide rod 721 by the connecting rod driving member, thereby driving the dust-scraping member 71 to reciprocate along the outside of the first filter structure 44 to scrape off the accumulated dust outside the first filter structure 44.

Further, the dust-scraping driving structure 72 also includes an elastic reset member 724 sleeved on the outside of the connecting rod 722. After the connecting rod driving member drives the connecting rod 722 to move to one end of the first filter structure 44, the connecting rod 722 is reset under the drive of the elastic force of the elastic reset member 724. The elastic reset member 724 can be configured as a telescopic spring.

There are various configurations of the first filter structure 44. In one embodiment, referring to FIG. 3 and FIG. 6, when the first filter structure 44 includes a filter screen mounting bracket 441 and the filter screen 442 disposed on the filter screen mounting bracket 441, the filter screen 442 is ring setting. The dust-scraping member 71 is sheathed on the outside of the filter screen 442. The elastic reset member 724 is connected to the guide rod 721 and the filter screen mounting bracket 441. The connecting rod driving member drives the connecting rod 722 to move towards one end of the filter screen 442, and the elastic reset member 724 drives the connecting rod 722 to move towards the other end of the filter screen 442, so that the connecting rod 722 can move back and forth to drive the dust-scraping member 71 to move back and forth on the outer surface of the filter screen 442 so as to scrape off the dust.

In order to make the structure of the handheld vacuum cleaner 100 more compact, the guide rod 721 is located between two of the conical cylinders 21 at intervals along the circumferential direction, so as not to occupy the space in the handheld vacuum cleaner 100 and make the volume of the handheld vacuum cleaner 100 smaller.

Further, the housing 11 defines an opening 15 extending along the axial direction of the first filter structure 44. The connecting rod driving member includes a driving handle 723. The driving handle 723 is connected with the connecting rod 722. Moreover, at least part of the driving handle 723 is exposed from the opening 15. The driving handle 723 is driven to slide along the opening 15 manually or by a mechanical arm, so as to scrape dust. For example, an initial position of the driving handle 723 is located at one end of the opening 15, and the driving handle 723 is manually held and slid along the opening. When the driving handle 723 moves to the other end of the opening, the dust-scraping member 71 can just move to the other end of the filter screen 442. At this time, the elastic rest member is in a contracted state. When the human hand releases the driving handle 723, the connecting rod 722 connected to the driving handle 723 returns to the initial position under the action of the stretching force of the elastic reset member 724. The dust-scraping member 71 then completes a back and forth scraping operation.

In order to facilitate dust-scraping when the user holds the handheld vacuum cleaner 100, the handheld structure 6 can be arranged on one side of the housing 11, and the driving handle 723 can be arranged on the other side of the housing 11. Preferably, the driving handle 723 and the handheld structure 6 are respectively arranged on opposite sides of the housing 11, so that the operation is more labor-saving.

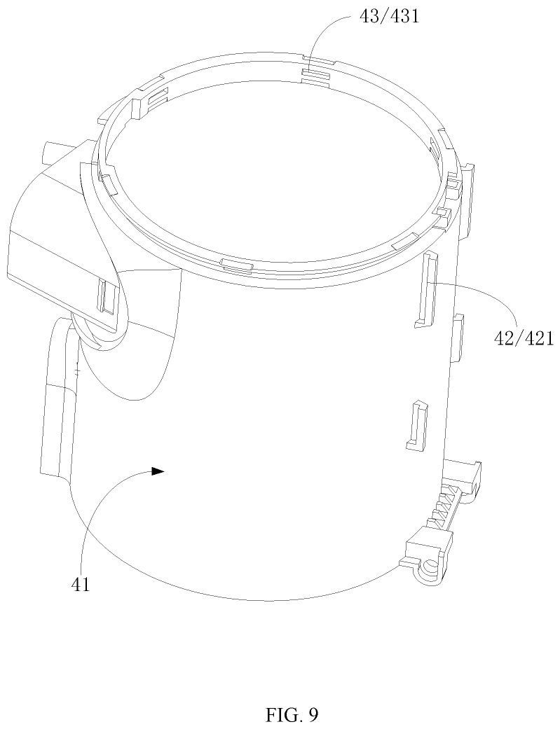

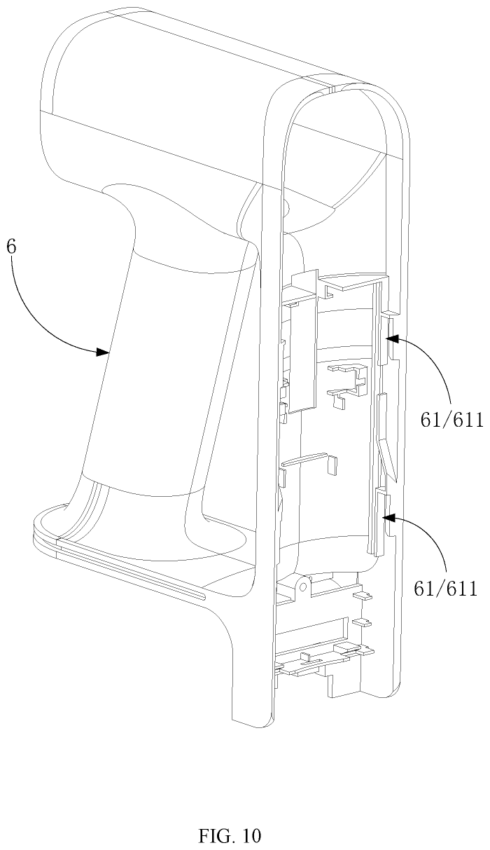

In order to facilitate the assembly of the handheld vacuum cleaner 100, referring to FIG. 9 and FIG. 10, a first mounting portion 42 is provided on the dust cup 41. The handheld structure 6 is provided with a first mating portion 61 mating with the first mounting portion 42. The first mounting portion 42 cooperates with the first mating portion 61 to install the dust cup 41 on the handheld structure 6.

In one embodiment, one of the first mounting portion 42 and the first mating portion 61 is configured as a sliding slot 611, and a remaining one of the first mounting portion 42 and the first mating portion 61 is configured as a slider 421 mated with the sliding slot 611. Wherein, the sliding slot 611 and/or the slider 421 are arranged in an “L” shape. During assembly, the slider 421 on the dust cup 41 can be inserted from the open end of the “L”-shaped sliding slot 611, and then crimped to one end of the dust cup 41 through the housing 11, thereby preventing the dust cup 41 from slipping off.

In order to facilitate the assembly of the dust cup 41 and the housing 11, a second mounting portion 43 is also provided on the dust cup 41. The housing 11 is provided with a second mating portion 14 mating with the second mounting portion 43. The second mounting portion 43 cooperates with the second mating portion 14 to connect the housing 11 and the dust cup 41.

In one embodiment, one of the second mounting portion 43 and the second mating portion 14 is configured as a hook 141, and a remaining one of the second mounting portion 43 and the second mating portion 14 is configured as a buckle portion 431 mated with the hook 141.

Specifically, referring to FIG. 5 and FIG. 9, one end of the dust cup 41 connected to the housing 11 is open. The buckle portion 431 is provided with a plurality of locking slots. The plurality of locking slots are arranged along the circumference of the opening of the dust cup 41. Correspondingly, the plurality of hooks 141 are provided, and the plurality of hooks 141 are provided in one-to-one correspondence with the plurality of locking slots, thereby making the connection between the dust cup 41 and the housing 11 more stable.

The above descriptions are only preferred embodiments of the present invention, and are not intended to limit the patent scope of the present invention. All equivalent structures made by utilizing the contents of the description and drawings of the present invention, or directly or indirectly used in other related technical fields, are equally included in the scope of patent protection of the present invention.

1. A handheld vacuum cleaner, comprising:
a dust cup assembly, comprising a dust cup and a first filter structure arranged in the dust cup, the first filter structure being arranged in a ring shape;
a multi-cone separator, comprising a plurality of conical cylinders arranged outside the first filter structure and located at one end of the first filter structure along an axial direction; air inlet ends of the plurality of conical cylinders being in fluid communication with an air outlet end of the first filter structure; and
a motor assembly, comprising a motor arranged outside the first filter structure, the motor and the plurality of conical cylinders being located at a same end of the first filter structure; an air inlet end of the motor being in fluid communication with an air outlet end of the multi-cone separator; the plurality of the conical cylinders at least partially surrounding a peripheral side of the motor.

2. The handheld vacuum cleaner according to claim 1, wherein the motor assembly further comprises a printed circuit board electrically connected to the motor, and the printed circuit board is located at an end of the motor adjacent to the first filter structure.

3. The handheld vacuum cleaner according to claim 2, wherein the plurality of conical cylinders are all arranged along an axial direction of the motor; a dust falling port is formed at a constricted end of each of the conical cylinders; an air outlet is formed at an open end of each of the conical cylinders; an air inlet of each of the conical cylinders is formed on a side wall of the conical cylinder and arranged adjacent to the open end; and the air inlet of each of the conical cylinders is located on a side of the printed circuit board facing away from a filter screen.

4. The handheld vacuum cleaner according to claim 1, wherein the air inlets of the conical cylinders are arranged between the air outlet end of the first filter structure and the air inlet end of the motor.

5. The handheld vacuum cleaner according to claim 1, wherein the motor and the first filter structure are arranged coaxially; or,
a central axis of the motor and a central axis of the first filter structure are arranged in a misaligned manner.

6. The handheld vacuum cleaner according to claim 1, wherein the plurality of the conical cylinders are arranged outside the motor along a circumferential direction of the motor, and the plurality of conical cylinders are arranged in an arc shape.

7. The handheld vacuum cleaner according to claim 2, wherein the dust cup assembly further comprises a dust guide cylinder arranged inside the first filter structure; the dust guide cylinder is arranged along the axial direction of the first filter structure; one end of the dust guide cylinder is arranged facing the motor and in communication with the dust falling ports of the plurality of conical cylinders; and another end of the dust guide cylinder is configured to discharge dust;
the dust guide cylinder and the first filter structure are arranged at intervals to form an air passing channel; the air passing channel is in fluid communication with the plurality of air inlets of the conical cylinders; the air passing channel is configured to deliver an airflow filtered by the first filter structure to the plurality of air inlets of the conical cylinders.

8. The handheld vacuum cleaner according to claim 7, wherein the motor assembly further comprises a motor mounting plate, the motor mounting plate closing an end of the dust guide cylinder facing the motor, the motor is installed on the motor mounting plate, a plurality of first through holes are opened on the motor mounting plate, and the plurality of first through holes are arranged in one-to-one correspondence with the plurality of dust falling ports of the conical cylinders.

9. The handheld vacuum cleaner according to claim 7, further comprising a housing mating with the dust cup; wherein an accommodating cavity is formed in the housing; both the motor assembly and the multi-cone separator are arranged in the accommodating cavity;
the multi-cone separator further comprises a separation cover plate arranged at the air outlets of the plurality of conical cylinders; the separation cover plate is configured to divide the accommodating cavity into a first cavity and a second cavity which are arranged along the axial direction of the motor; the separation cover plate defines a plurality of second through holes arranged in one-to-one correspondence with the plurality of air outlets of the conical cylinders; the air inlets of the conical cylinders are located in the second cavity; and
the air inlet end of the motor is located in the first cavity.

10. The handheld vacuum cleaner according to claim 9, wherein the air inlet end of the motor defines a plurality of air inlet holes which are arranged annularly along a circumferential direction of the motor;
the handheld vacuum cleaner further comprises a second filter structure arranged in the first cavity; the second filter structure is arranged surrounding an outside of the plurality of air inlet holes; the plurality of second through holes are arranged on an outside of the second filter structure; and/or,
the air outlet end of the motor is located in the second cavity; the handheld vacuum cleaner further comprises a handheld structure arranged on one side of the housing; an air outlet hole is opened on the handheld structure; the handheld structure defines an air outlet channel in communication with the air outlet hole and the air outlet end of the motor; and the air outlet channel and the air passing channel are arranged separately.
